(19) United States
(12) Patent Application Publication
(10) Pub. No.: US 2013/0307550 A1
(43) Pub. Date: Nov. 21, 2013

(54) STATE OF CHARGE INDICATORS FOR BATTERY PACKS

(71) Applicant: O2MICRO INC., Santa Clara, CA (US)

(72) Inventors: William DENSHAM, Los Gatos, CA (US); Laszlo LIPCSEI, Campbell, CA (US); Flavius LUPU, San Jose, CA (US)

(73) Assignee: O2Micro Inc., Santa Clara, CA (US)

(21) Appl. No.: 13/874,118

(22) Filed: Apr. 30, 2013

Related U.S. Application Data
(60) Provisional application No. 61/648,971, filed on May 18, 2012.

(51) Int. Cl. H01M 10/48

(52) U.S. Cl. CPC H01M 10/482
USPC 324/433; 429/90; 324/426

(57) ABSTRACT

A state-of-charge (SOC) indicator for a battery pack is provided. The operation of the indicator is changed from a first mode to a second mode if a mechanism is activated, and is changed to a third mode if the mechanism remains activated after a timer expires. The indicator consumes a first amount of power in the second mode, and consumes a second amount of power which is less than the first amount in the third mode. The indicator blinks with a regular frequency when the SOC is less than a threshold. A comparator compares a divided signal and a reference signal during a first time interval, and the indicator displays the SOC based upon the comparison result during a second time interval separated from the first time interval.

### RELATED APPLICATIONS

This application claims priority to the U.S. provisional application Ser. No. 61/648,971, titled “Battery Pack State of Charge Indicators,” filed on May 18, 2012, which is hereby incorporated by reference in its entirety.

### BACKGROUND

State of charge (SOC) is a measure of the energy presently stored in a battery pack compared to a fully charged battery pack. For example, a battery pack described as one-half full has an SOC of 50%.

In the past, only a few high-end battery packs, such as those used for power tools, had SOC indicators for their battery packs. Many of the low- and medium-end power tool battery packs do not have an SOC indicator. Those battery packs that do have SOC indicators are implemented using discrete components. However, many end users find it valuable to know the battery's SOC prior to starting a project. For example, before climbing a ladder to work on the roof, it is very helpful to know how much energy is in a power tool's battery pack.

The SOC indicators are typically implemented using a set of lights such as light-emitting diodes (LEDs). The number of LEDs that are lit indicates the SOC. That is, each LED is associated with a respective SOC threshold and is lit if that threshold is reached.

There are a number of issues with conventional SOC indicators. FIG. 1 illustrates a diagram 100 of power modes in a conventional SOC indicator for a battery pack. There is usually a push button to activate the SOC monitor and SOC indicator function for a fixed period of time. As shown in FIG. 1, the SOC indicator includes a standby mode and a normal mode. When the push button is released (not depressed), the SOC indicator operates in the standby mode with very low current consumption waiting for push button activation. When the push button is depressed, the SOC indicator operates in the normal mode, in which the SOC indicator displays the SOC of the battery pack.

However, the push button may cause a fault condition that could damage the battery pack. For example, when the battery pack is stored in a tool box, the push button may accidentally be activated in a continuous manner. That is, the button may be accidentally and continuously depressed because it is pressed up against something else in the tool box. Consequently, the SOC monitor and SOC indicator are turned on, which results in a continuous current drain from the battery pack of about 10 to 20 milli-amps (mA). A typical fully charged lithium-ion (Li-ion) cell may have 1500 mA-hours of energy stored. If the battery has been used all day, it may have only about 500 mA-hours of energy remaining. In the latter case, with a current drain of 20 mA, it may take only slightly more than a day to drain all the remaining energy. Over a long weekend or if there are a few weeks between use, the battery may be completely discharged. Completely discharging a Li-ion battery can damage the battery pack and shorten its cycle life and age.

Another issue with conventional SOC indicators is that the lowest SOC is indicated by turning off all of the LEDs, which may confuse the user as to the actual SOC. FIG. 2 illustrates a diagram 200 of multiple states of a conventional SOC indicator when operating in the normal mode. In FIG. 2, the SOC indicator includes three LEDs, and the SOC indicator can operate in state 202, 204, 206, or 208. For illustrative purposes, in FIG. 2, a black LED represents the corresponding LED is turned on, and a white LED represents the corresponding LED is turned off. In the state 202, when the SOC of the battery pack is greater than a first threshold T1 (e.g., when the battery pack is fully charged), the SOC indicator displays the SOC with all LEDs on and lighted. As the SOC decreases with usage, one by one the LEDs are extinguished. For example, when the SOC is greater than a second threshold T2 but less than the first threshold T1 in the state 204, two LEDs remain on while one is off. When the SOC is greater than a third threshold T3 but less than the second threshold T2 in the state 206, one LED remains on while the other two are off. In the state 208, when the lowest SOC is finally reached, e.g., the SOC is less than the third threshold T3, all the LEDs are turned off. However, the user may be confused when all the LEDs are off. For example, all the LEDs may be off because of failure of the LEDs, failure of the push button, or failure of the battery pack, and therefore the user cannot be sure whether one of those problems has occurred or whether the battery pack is in the lowest SOC.

Another issue with conventional SOC indicators occurs when the SOC is almost exactly at one of the thresholds (e.g., at T1, T2, and T3). In such cases, the LEDs may flicker as the SOC changes because of electrical noise or some other reason. For example, if the battery pack voltage input to a comparator is almost exactly the same voltage as the reference threshold voltage input to the comparator, then the output may erratically alternate between a logical “1” and “0” because the battery pack voltage may experience significant noise modulation as a result of load variations or variations occurring internal to the cells. As the comparator output changes back-and-forth between “1” and “0,” the LEDs will flicker. This is distracting to the user and also does not provide a clear indication of the actual SOC.

In summary, conventional SOC indicators for the battery packs are susceptible to fault conditions that can drain the battery, and do not always provide an unambiguous indication of SOC.

### SUMMARY

An embodiment according to the present invention provides a method of operating a state-of-charge (SOC) indicator for a battery pack. The method includes: with the SOC indicator in a first state, changing operation of the SOC indicator to a second mode if a mechanism is activated; and changing operation of the SOC indicator from the second mode to a third mode if the mechanism remains activated after a timer expires. The SOC indicator consumes a first amount of power in the second mode, and consumes a second amount of power in the third mode. The second amount is less than the first amount.

Another embodiment according to the present invention provides an apparatus for indicating a state-of-charge (SOC) of a battery pack. The apparatus includes a first indicator and a second indicator. The first indicator is turned on when the SOC is greater than a first threshold and is turned off when the SOC is less than the first threshold. The second indicator is turned on when the SOC is greater than a second threshold and blinks with a regular frequency when said SOC is less than the second threshold. The second threshold is less than the first threshold.

Another embodiment according to the present invention provides a circuit for monitoring state-of-charge (SOC) of a battery pack. The circuit includes a divider, a first comparator, and data storage. The divider receives a battery pack voltage and generates a first divided signal and a second divided signal that correspond to the battery pack voltage. The first comparator compares the first divided signal and a reference signal during a first time interval, and generates a first comparing signal indicating the SOC of the battery pack based upon a result of the comparison. The data storage coupled to the first comparator stores the first comparing signal. A SOC indicator displays the SOC of the battery pack during a second time interval based upon the first comparing signal stored in the data storage. The second time interval is separated from the first time interval.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 illustrates a diagram of power modes in a conventional SOC indicator.

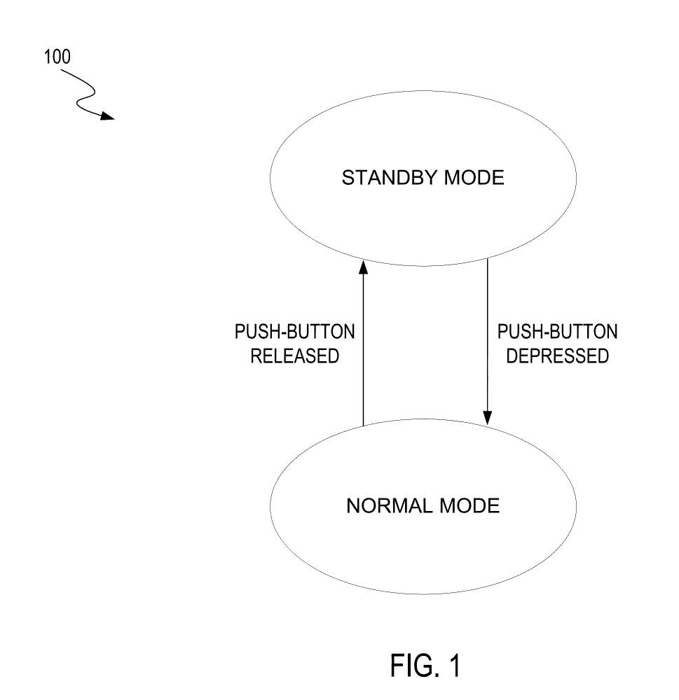

FIG. 2 illustrates a diagram of multiple states of a conventional SOC indicator when operating in a normal mode.

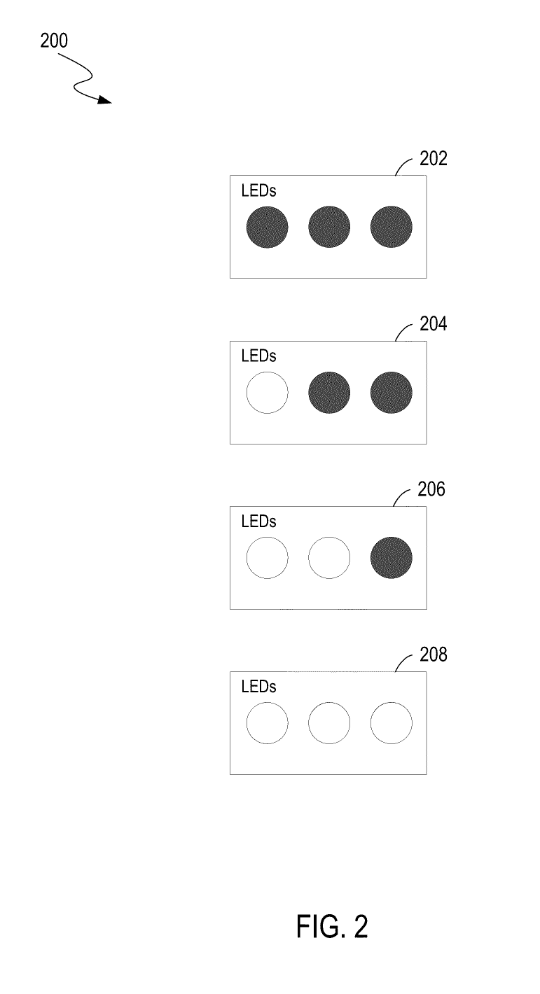

FIG. 3 illustrates a block diagram of a battery system, in an embodiment according to the present invention.

FIG. 4 illustrates a diagram of power modes of a monitoring circuit and an SOC indicator, in an embodiment according to the present invention.

FIG. 5 illustrates a flowchart of operations performed by a mode detector, in an embodiment according to the present invention.

FIG. 6 illustrates a diagram of multiple states of an SOC indicator when operating in a normal mode, in an embodiment according to the present invention.

FIG. 7A illustrates a diagram of an indicating circuit, in an embodiment according to the present invention.

FIG. 7B illustrates a diagram of an indicating circuit, in another embodiment according to the present invention.

FIG. 8 illustrates a monitoring circuit, in an embodiment according to the present invention.

FIG. 9 illustrates a timing diagram of signals associated with a monitoring circuit, in an embodiment according to the present invention.

FIG. 10 illustrates a monitoring circuit, in another embodiment according to the present invention.

FIG. 11 illustrates a timing diagram of signals associated with a monitoring circuit, in an embodiment according to the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments in accordance with the present invention provide methods of operating state-of-charge (SOC) indicators for battery packs, apparatuses for indicating a SOC for battery packs, and circuits for monitoring SOC of the battery pack. In one embodiment, the method includes: with the SOC indicator in a first state, changing operation of the SOC indicator to a second mode if a mechanism is activated; and changing operation of the SOC indicator from the second mode to a third mode if the mechanism remains activated after a timer expires. The SOC indicator consumes a first amount of power in the second mode, and consumes a second amount of power in the third mode. The second amount is less than the first amount. Advantageously, the low-power mode gives the battery pack a sufficient period of time to survive the discharge fault condition before becoming fully discharged, therefore mitigating the effects of a fault condition.

In one embodiment, the apparatus includes a first indicator and a second indicator. The first indicator is turned on when the SOC is greater than a first threshold and is turned off when the SOC is less than the first threshold. The second indicator is turned on when the SOC is greater than a second threshold and blinks with a regular frequency when said SOC is less than the second threshold. The second threshold is less than the first threshold. Advantageously, a positive and unambiguous indication is provided when the lowest SOC is reached.

In one embodiment, the circuit includes a divider, a first comparator, and data storage. The divider receives a battery pack voltage and generates a first divided signal and a second divided signal that correspond to the battery pack voltage. The first comparator compares the first divided signal and a reference signal during a first time interval, and generates a first comparing signal indicating the SOC of the battery pack based upon a result of the comparison. The data storage coupled to the first comparator stores the first comparing signal. A SOC indicator displays the SOC of the battery pack during a second time interval based upon the first comparing signal stored in the data storage. The second time interval is separated from the first time interval. Advantageously, the user will see a stable SOC indication each time the push button is activated.

### Protection Against Fault Conditions

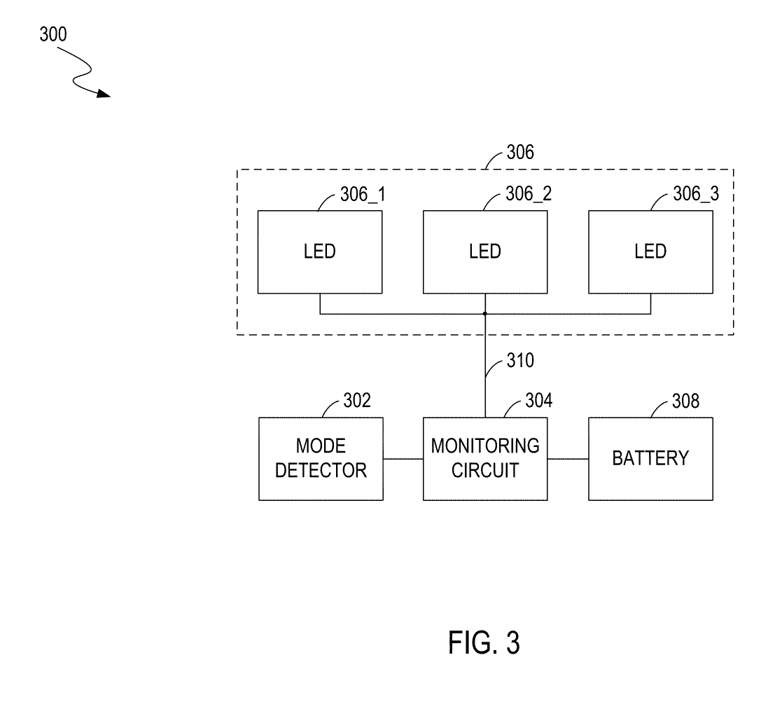

FIG. 3 illustrates a block diagram of a battery system 300, in an embodiment according to the present invention. In one embodiment, the battery system 300 includes a mode detector 302, a monitoring circuit 304, a battery 308, and a SOC indicator 306. As shown in the example of FIG. 3, the SOC indicator 306 includes three LEDs 306_1, 306_2, and 306_3. However, the embodiment shown in FIG. 3 is only for illustrative purposes; there can be any number of LEDs, depending on the requirements of particular applications.

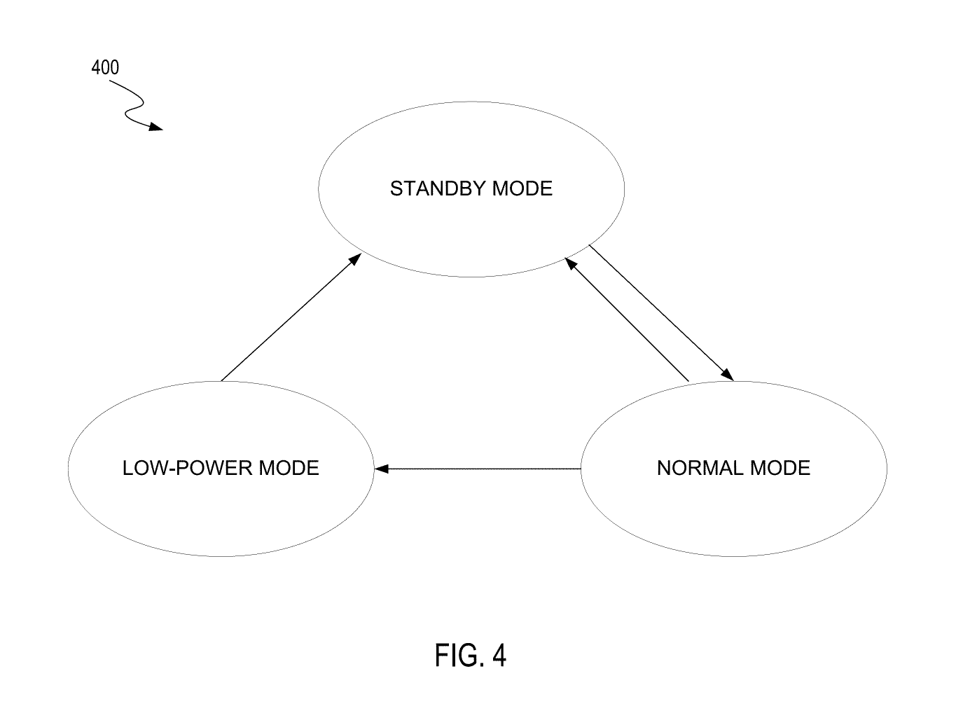

In one embodiment, the mode detector 302 includes a push button (not shown) and determines a mode for the monitoring circuit 304 and the SOC indicator 306. FIG. 4 illustrates a diagram 400 of multiple power modes of the monitoring circuit 304 and SOC indicator 306, in an embodiment according to the present invention. As shown in FIG. 4, the SOC monitoring circuit 304 and the SOC indicator 306 can operate in a standby mode, a normal mode, or a low-power mode, in one embodiment. In the following description, FIG. 4 is described in combination with FIG. 3.

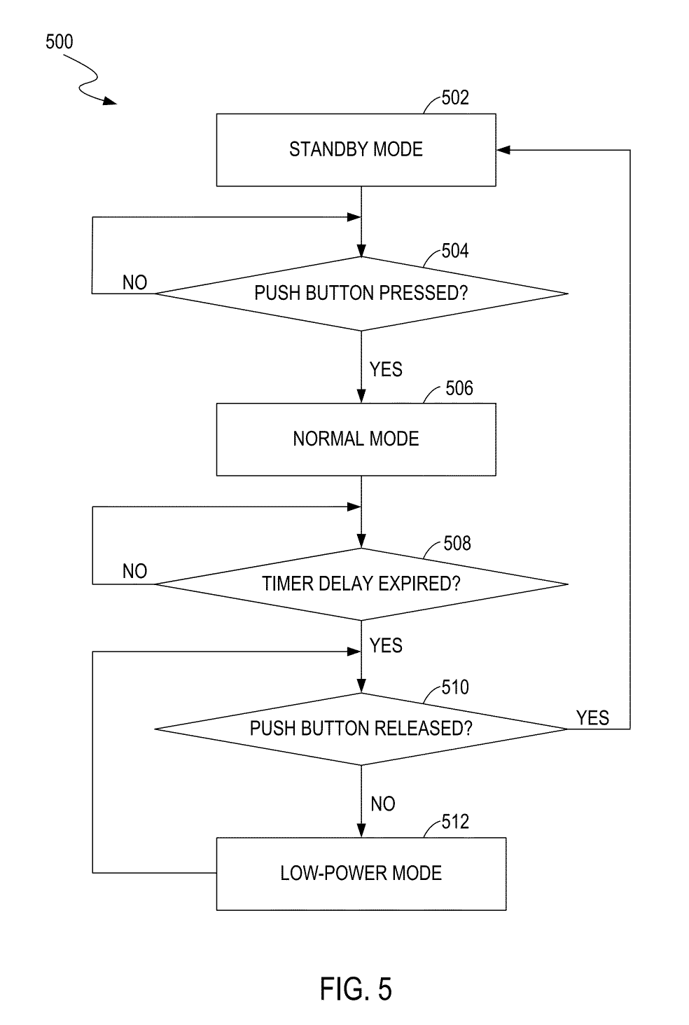

When operating in the standby mode, the monitoring circuit 304 and the SOC indicator 306 are inactive and consume a first amount of power. When operating in the normal mode, the monitoring circuit 304 and the SOC indicator 306 are active and operate with a second amount of power which is much higher than the first amount. When operating in the low-power mode, the monitoring circuit 304 and the SOC indicator 306 may consume a third amount of power which is higher than the first amount but still much lower, e.g., 1000 times lower, than the second amount of power. For example, the low-power mode may operate at a current of about 10 micro-amps, while the standby mode operates at a current of about 0.25 micro-amps (about 250 nano-amps). How the mode detector 302 selects a mode from the standby mode, the normal mode, and the low-power mode is further described in FIG. 5.

In one embodiment, when the normal mode is detected by the mode detector 302, the monitoring circuit 304 monitors the SOC of the battery 308, and generates a control signal 310 indicating the SOC to the SOC indicator 306. Accordingly, the SOC indicator 306 displays the SOC of the battery 308 by turning on or turning off the LEDs 306_1, 306_2 and 306_3.

FIG. 5 illustrates a flowchart 500 of operations performed by a mode detector (e.g., the mode detector 302), in an embodiment according to the present invention. FIG. 5 is described in relation to FIG. 3 and FIG. 4.

In block 502, in one embodiment, the monitoring circuit 304 and the SOC indicator 306 operate in the standby mode.

In block 504, the mode detector 302 determines whether a mechanism is activated, for example, the mode detector 302 determines whether a push button has been pressed (e.g., pushed by a user). In general, the mechanism is not limited to the push button; another mechanism can also be used depending on the requirements of particular applications. If the push button has not been pressed, the monitoring circuit 304 and the SOC indicator 306 remain in the standby mode. If the push button has been pressed, in response, the monitoring circuit 304 and the SOC indicator 306 are activated and transform from the standby mode to the normal mode, as shown in block 506.

When operating in the normal mode in block 506, the monitoring circuit 304 and the SOC indicator 306 are activated and a delay timer (not shown) is started. Because a delay timer is used, a microcontroller is not necessary, thus reducing cost.

In block 508, the monitoring circuit 304 monitors the delay timer to track the moment when the delay timer has expired, and a determination is made with regard to whether the delay timer has been expired. Until the time delay has terminated, the delay timer will continue to measure time. In one embodiment, the delay timer has a period of 4 seconds. Generally speaking, the delay timer has a period that is long enough to detect the SOC of the battery pack but short enough to avoid unnecessarily consuming the battery charge. If the delay timer expires, the flowchart 500 proceeds to block 510.

In block 510, the mode detector 302 determines whether the mechanism is deactivated. For example, the mode detector 302 determines if the push button has been released. If the push button has been released (that is, it is no longer depressed), the battery system 300 is operating normally, and the monitoring circuit 304 and the SOC indicator 306 are transformed to the standby mode in block 502 to wait for the next depression of the push button.

However, in block 510, if the mode detector 302 determines that the push button has not been released (remains depressed), then the monitoring circuit 304 and the SOC indicator 306 are transformed to the low-power mode in block 512. The monitoring circuit 304 and the SOC indicator 306 remain in the low-power mode until the push button is released. In one embodiment, the power consumed in the low-power mode is less than the power consumed in the normal mode, e.g., the power consumed in the low-power mode is 1000 times lower than power consumed in the normal mode. After the push button is released, the monitoring circuit 304 and the SOC indicator 306 will transform to the standby mode to wait for the next depression of the push button.

Advantageously, the low-power mode gives the battery pack a sufficient period of time to survive a discharge fault condition before becoming fully discharged, therefore mitigating the effects of a fault condition when, for example, the push button is continuously depressed, by accident or otherwise. The length of battery survival time is dependent upon the SOC of the battery prior to entering the fault condition.

### Positive Indicator of SOC

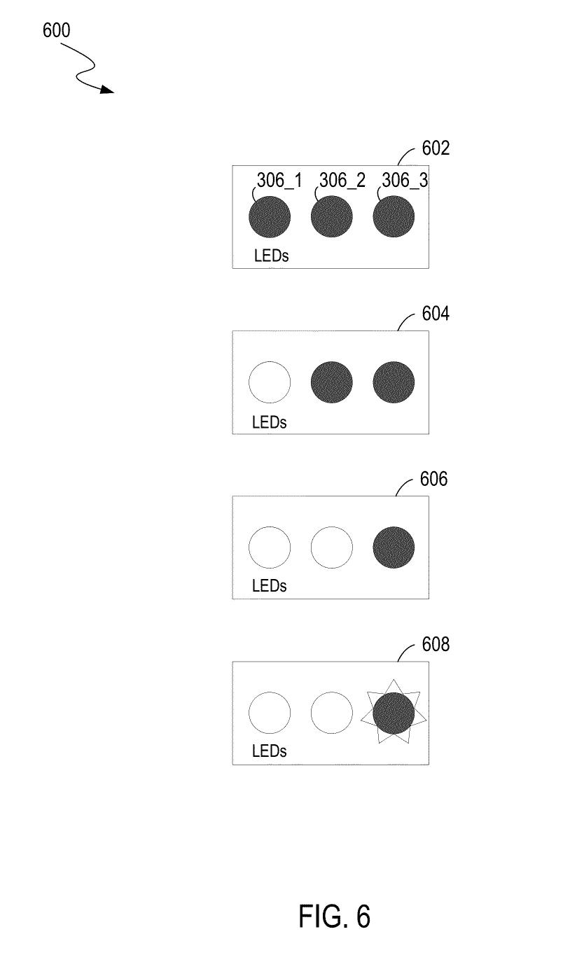

FIG. 6 illustrates a diagram 600 of multiple states of an SOC indicator (e.g., the SOC indicator 306) when operating in the normal mode, in an embodiment according to the present invention. Elements labeled the same as in FIG. 3 have similar functions. FIG. 6 is described in relation to FIG. 3.

In one embodiment, the SOC of the battery pack has a first threshold T1, a second threshold T2, and a third threshold T3, wherein T1 is greater than T2, which is greater than T3, that is, T1>T2>T3. The SOC indicator 306 displays the SOC with LEDs 306_1, 306_2, and 306_3 according to a comparison result of the SOC of the battery back and the thresholds (e.g., T1, T2, and T3). In one embodiment, the LED 306_1 is turned on when SOC is greater than T1, and is turned off when SOC is less than T1. The LED 306_2 is turned on when SOC is greater than T2, and is turned off when SOC is less than T2. The LED 306_3 is turned on when SOC is greater than T3, and blinks when SOC is less than T3.

Therefore, the SOC indicator 306 can operate in state 602, 604, 606, or 608, for example. Specifically, as shown in FIG. 6, when the SOC is above the first threshold T1, the SOC indicator 306 operates in the state 602 in which the LEDs 306_1, 306_2 and 306_3 are all turned on. When the SOC is greater than the second threshold T2 but less than the first threshold T1, the SOC indicator 306 operates in the state 604 in which the LED 306_1 is turned off and LEDs 306_2 and 306_3 are turned on. When the SOC is greater than the third threshold T3 but less than the second threshold T2, the SOC indicator 306 operates in the state 606 in which the LEDs 306_1 and 306_2 are turned off and LED 306_3 is turned on. When the SOC is below the third threshold T3, the SOC indicator 306 operates in the state 608 in which the LEDs 306_1 and 306_2 are turned off while LED 306_3 blinks with a regular frequency (e.g., occurring in a fixed or predictable pattern, and/or with equal amounts of time between each blink). Therefore, in one embodiment, the LED 306_3 is continuously on when the SOC is equal to or greater than the lowest threshold (e.g., the third threshold T3), and blinks at a regular rate when the SOC is less than the lowest threshold. Advantageously, since the LED 306_3 blinks when the SOC is the lowest, e.g., in the state 608, a positive and unambiguous indication is reached.

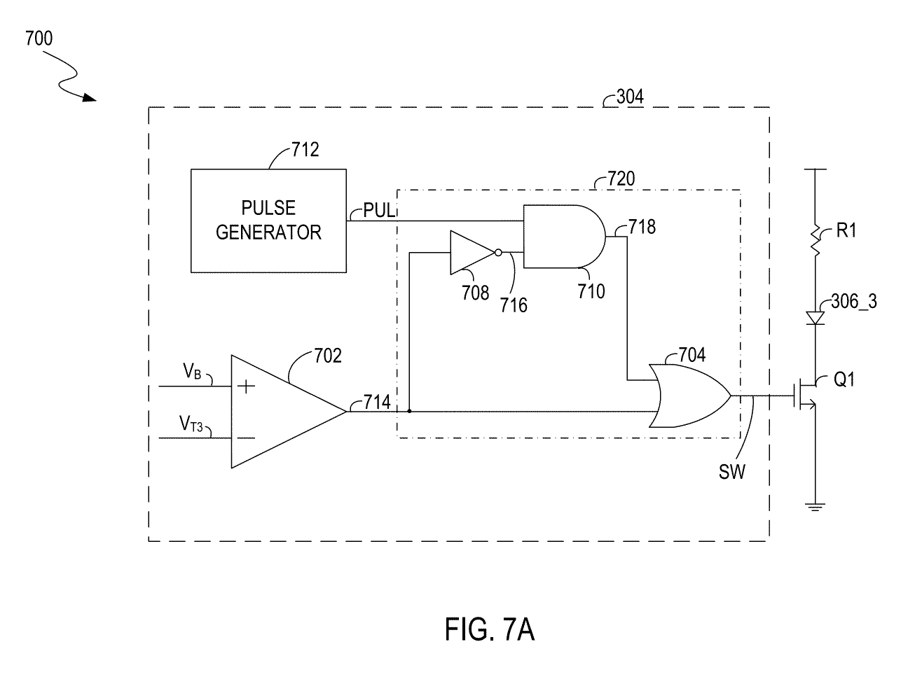

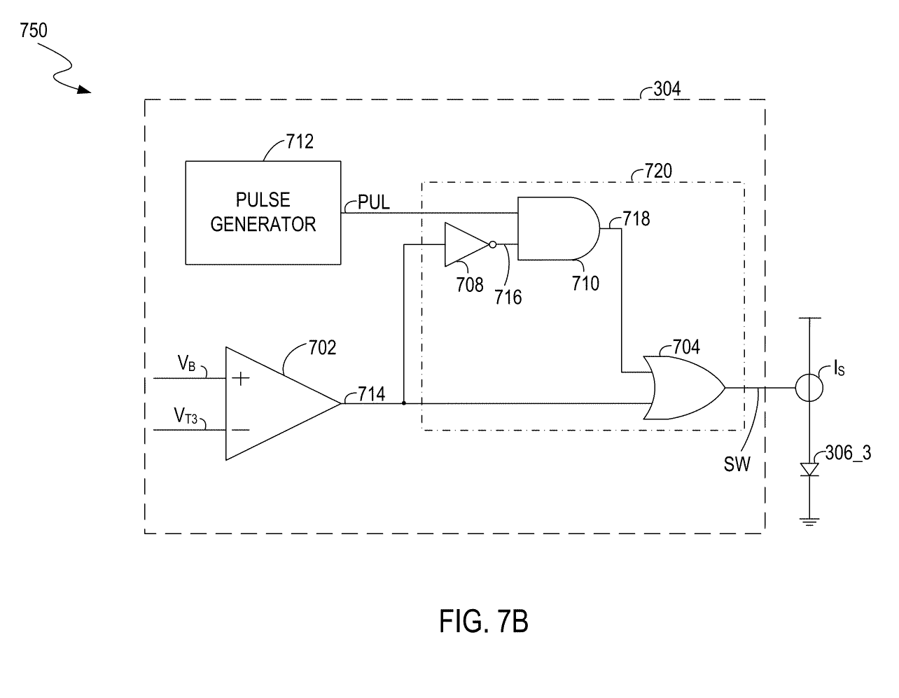

FIG. 7A illustrates a diagram of an indicating circuit 700, in an embodiment according to the present invention. Elements labeled the same as in FIG. 3 have similar functions. FIG. 7A is described in relation to FIG. 3 and FIG. 6. In one embodiment, the indicating circuit 700 can be included in a single integrated circuit along with the delay timer mentioned above.

In one embodiment, the indicating circuit 700 includes the monitoring circuit 304 coupled to the LED 306_3. A resistor R1, the LED 306_3, and a transistor Q1 are coupled in series. The monitoring circuit 304 includes a voltage comparator 702, a pulse generator 712, and a logic circuit 720, in one embodiment. The voltage comparator 702 compares a battery pack voltage V_{B} and a third predetermined reference voltage V_{T3} indicative of the third threshold T3, and generates a comparison signal 714 based upon a result of the comparison. The pulse generator 712 generates a pulse signal PUL. The logic circuit 720 receives the comparison signal 714 and the pulse signal PUL, and accordingly provides a switching signal SW to the transistor Q1. The transistor Q1 is turned on or off according to the switching signal SW, so as to conduct or not conduct a current through the LED 306_3.

In one embodiment, the logic circuit 720 includes an inverter gate 708, an AND gate 710, and an OR gate 704. The AND gate 710 receives the comparison signal 714 via the inverter gate 708 and receives the pulse signal PUL generated by the pulse generator 712. Accordingly, the AND gate 710 generates a signal 718. The OR gate 704 receives the signals 714 and 718, and outputs the switching signal SW to the transistor Q1. In one embodiment, the signals 714, PUL, 718, and SW are digital signals. In one embodiment, the transistor Q1 can be an N-type metal-oxide-semiconductor-field-effect transistor (MOSFET), which is, for example, conducted on when the switching signal SW has a first level (e.g., represented by logic “1”), and cut off when the switching signal SW has a second level (e.g., represented by logic “0”).

More specifically, if the battery pack voltage V_{B} is greater than the third predetermined reference voltage V_{T3}, then the voltage comparator 702 outputs the comparison signal 714 in a first state, for example, logic “1” state. The comparison signal 714 in logic “1” state is presented to the input of the OR gate 704, and accordingly the switching signal SW has a first value, e.g., logic “1”, to turn on the transistor Q1. Thus, a current is conducted through the resistor R1, the LED 306_3, and the transistor Q1, to ground. As such, the LED 306_3 is turned on. In one embodiment, the LED current is limited by the resistor R1.

If the battery pack voltage V_{B} is less than the third predetermined reference voltage V_{T3}, then the voltage comparator 702 outputs the comparison signal 714 in a second state, for example, logic “0” state. The inverter 708 receives the comparison signal 714 in logic “0” and presents a signal 716 in logic “1” to the AND gate 710. The signal 716 in logic “1” enables the AND gate 710 to pass the pulse signal PUL from the pulse generator 712 to the OR gate 704. Accordingly, the switching signal SW will switch between a first value (e.g., logic “1”) and a second value (e.g., logic “0”) as the pulse signal PUL does, and toggle the transistor Q1 with the frequency of the pulse signal PUL. Accordingly, the current through LED 306_3 is conducted on and off alternately. Therefore, the LED 306_3 blinks at a rate equal to the frequency of the pulse signal PUL. In one embodiment, the pulse signal PUL has a frequency of 2 Hz. The resultant current in the transistor Q1 will modulate the LED 306_3, which will blink and thus provide a visual alert to the user.

FIG. 7B illustrates a diagram of an indicating circuit 750, in an embodiment according to the present invention. Elements labeled the same as in FIG. 7A have similar functions. In FIG. 7B, a current generator I_{S} is coupled to the LED 306_3 in series. In one embodiment, the current generator I_{S} internal to the integrated circuit may be used to provide the current through the LED 306_3. The current generator I_{S} can be modulated/switched by the switching signal SW to cause the LED 306_3 to blink.

Advantageously, the LED 306_3 blinks at a regular frequency (e.g., 2 Hz) when the lowest SOC (the state 608 in FIG. 6) is reached. More generally, a positive indication is provided when the lowest SOC is reached. The blink frequency and stability can be distinguished from a flickering LED. In this manner, an unambiguous alert is presented to a user when the lowest SOC is reached. Consequently, the user is not left with any concerns with regard to whether, for example, the LEDs have failed, the push button has failed, or the battery pack has failed.

SOC Indicator without Flicker

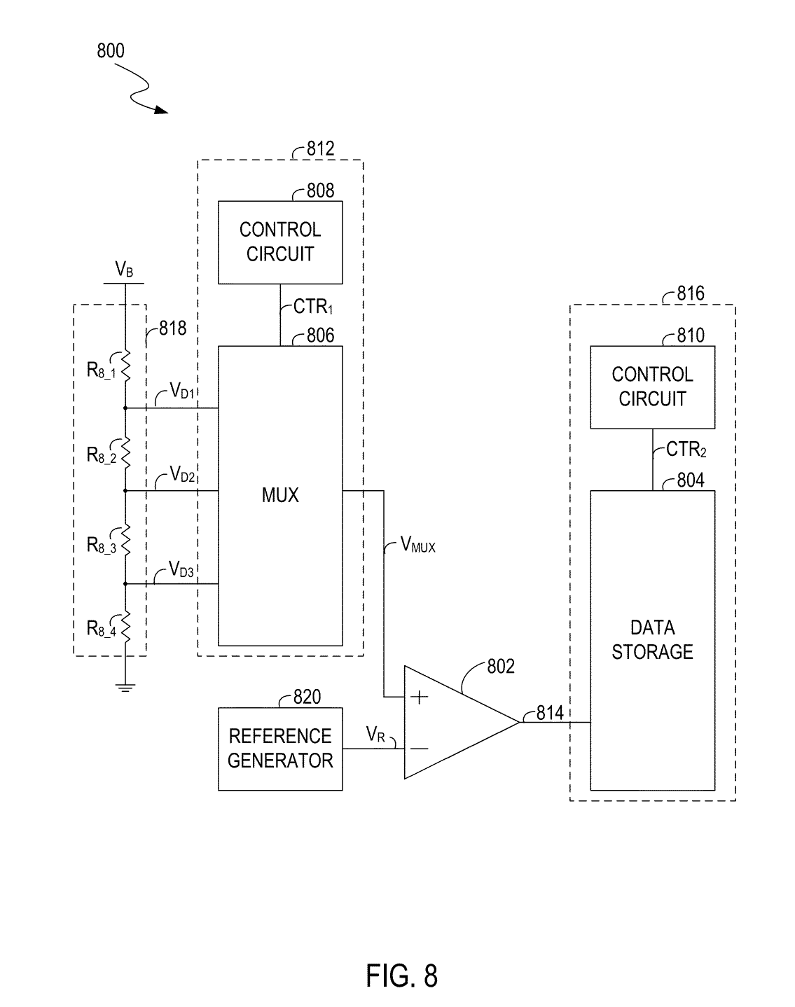

FIG. 8 illustrates an example of a monitoring circuit 800 (e.g., the monitoring circuit 304 of FIG. 3), in an embodiment according to the present invention. The monitoring circuit 800 can be included in a single integrated circuit along with the delay timer mentioned above and along with the features of the monitoring circuits of FIG. 7A and FIG. 7B.

In one embodiment, the monitoring circuit 800 includes a divider 818, a multiplexing module 812, a reference generator 820, a comparator 802, and a storage module 816. In one embodiment, the divider 818 includes four resistors R₈_{_{—}}₁, R₈_{_{—}}₂, R₈_{_{—}}₃, and R₈_{_{—}}₄ coupled in series. The divider 818 receives the battery pack voltage V_{B} and accordingly generates multiple divided voltages V_{D1}, V_{D2} and V_{D3} indicating the battery pack voltage V_{B}.

In one embodiment, the multiplexing module 812 includes a multiplexer 806 and a control circuit 808. The multiplexer 806 receives the divided voltages V_{D1} to V_{D3}, and selects a signal V_{MUX} from V_{D1} to V_{D3} in sequence according to a control signal CTR₁ generated by the control circuit 808. In one embodiment, the control signal CTR₁ includes three digital signals CTR₁_{_{—}}₁, CTR₁_{_{—}}₂, and CTR₁_{_{—}}₃. More specifically, when the signal CTR₁_{_{—}}₁ is active, the signal CTR₁_{_{—}}₁ enables the multiplexer 806 to select the signal V_{MUX} equal to the divided signal V_{D1}. When the signal CTR₁_{_{—}}₂ is activated afterwards, the signal CTR₁_{_{—}}₂ enables the multiplexer 806 to select the signal V_{MUX} equal to the divided signal V_{D2}. When the signal CTR₁_{_{—}}₃ is activated afterwards, the signal CTR₁_{_{—}}₃ enables the multiplexer 806 to select the signal V_{MUX} equal to the divided signal V_{D}_{_{—}}₃.

In one embodiment, the reference generator 820 generates a reference signal V_{R}. The comparator 802 then compares the signal V_{MUX} and the reference signal V_{R} to generate a comparing signal 814 based upon a result of the comparison. In other words, the comparator 802 compares the divided voltages V_{D1}, V_{D2}, V_{D3} with the reference signal V_{R} in sequence.

In one embodiment, the ratio between the resistors R₈_{_{—}}₁, R₈_{_{—}}₂, R₈_{_{—}}₃, and R₈_{_{—}}₄ are preset according to the reference signal V_{R} and the thresholds (e.g., T1, T2, and T3), such that comparisons between the divided voltages of the battery pack voltage V_{B} and the reference signal V_{R} can indicate the SOC of the battery pack. More specifically, for example, a first predetermined reference voltage V_{T1} may be indicative of the threshold T₁ corresponding to an SOC of 80%, a second predetermined reference voltage V_{T2} may be indicative of the threshold T₂ corresponding to an SOC of 40%, and a third predetermined reference voltage V_{T3} may be indicative of the threshold T₃ corresponding to an SOC of 25%. In one embodiment, a ratio between the total resistance R_{T} of the resistors R₈_{_{—}}₁ to R₈_{_{—}}₄ and the resistance of the resistor R₈_{_{—}}₄ is set equal to a ratio between the first predetermined reference voltage V_{T1} and the reference signal V_{R}, as shown in equation (1),

R_{T}/R₈_{_{—}}₄=V_{T1}/V_{R}. (1)

In one embodiment, a ratio between the total resistance R_{T} and a sum of the resistances of the resistor R₈_{_{—}}₃ and R₈_{_{—}}₄ is set equal to a ratio between the second predetermined reference voltage V_{T2} and the reference signal V_{R}, as shown in equation (2),

R_{T}/(R₈_{_{—}}₃+R₈_{_{—}}₄)=V_{T2}/V_{R}. (2)

In one embodiment, a ratio between the total resistance R_{T} and a sum of the resistances of the resistor R₈_{_{—}}₂ to R₈_{_{—}}₄ is set equal to a ratio between the third predetermined reference voltage V_{T3} and the reference signal V_{R}, as shown in equation (3),

R_{T}/(R₈_{_{—}}₂+R₈_{_{—}}₃+R₈_{_{—}}₄)=V_{T3}/V_{R}. (3)

Therefore, when the divided voltages V_{D1} to V_{D3} are selected and compared with the reference signal V_{R} in sequence and are all greater than the reference signal V_{R}, the battery pack voltage V_{B} is indicated to be greater than the first predetermined reference voltage V_{T1}, which further indicates that the SOC of the battery pack is above 80%, for example. When the voltages V_{D1} and V_{D2} are greater than the reference signal V_{R} and the voltage V_{D3} is less than V_{R}, it indicates the battery pack voltage V_{B} is greater than the second predetermined reference voltage V_{T2} but less than the first predetermined reference level V_{T1}. As such, the SOC of the battery pack is above 40% but below 80%, for example. When only the voltage V_{D1} is greater than V_{R}, and the voltages V_{D2} and V_{D3} are both less than V_{R}, it indicates the battery pack voltage V_{B} is greater than the third predetermined reference voltage V_{T3} but less than the second predetermined reference level V_{T2}. As such, the SOC of the battery pack is above 25% but below 40%, for example. When the voltages V_{D1} to V_{D3} are all less than V_{R}, it indicates the battery pack voltage V_{B} is less than the third predetermined reference voltage V_{T3}. As such, the SOC of the battery pack is below 25%, for example. Consequently, by comparing the divides voltages with the reference signal V_{R}, the SOC of the battery pack can be monitored.

In one embodiment, the storage module 816 includes a data storage 804 and a control circuit 810 coupled together. The data storage 804 can be implemented using latches or a register, for example. The data storage 804 receives the comparing signal 814 and stores the comparing signal 814 according to a control signal CTR₂ generated by the control circuit 810. In other words, the data storage 804 sequentially stores the comparison results between the reference voltage V_{R} and each of the divides voltages V_{D1} to V_{D3}.

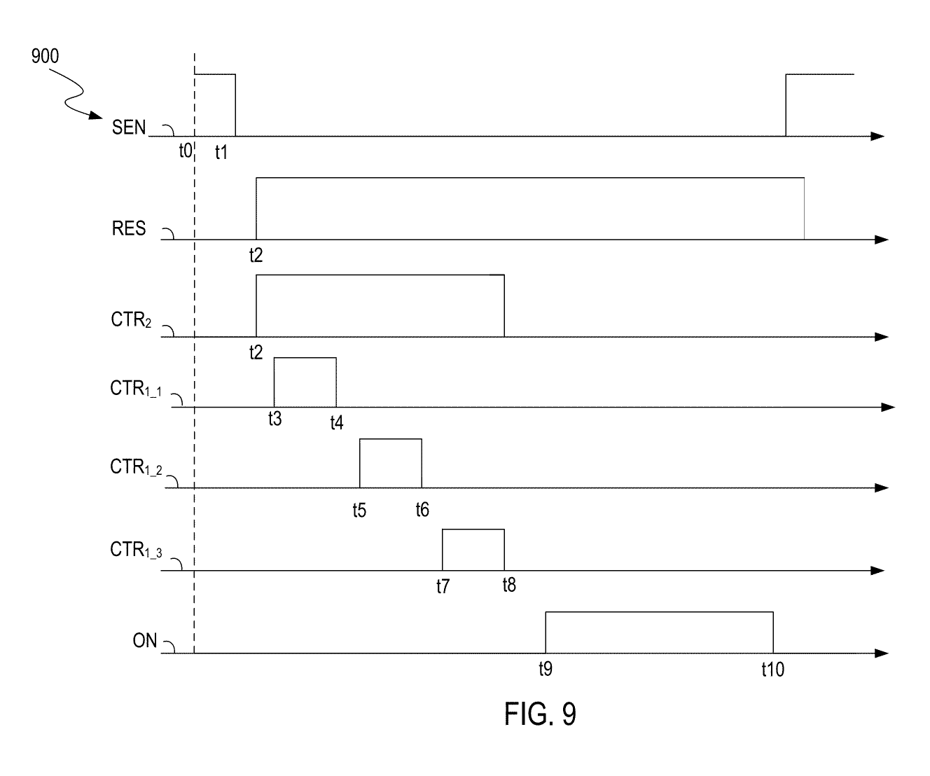

FIG. 9 illustrates a timing diagram 900 of signals associated with the monitoring circuit 800, in an embodiment according to the present invention. FIG. 9 is described in relation to FIG. 8. FIG. 9 shows a push-button sensing signal SEN that indicates if a button is pushed, a push-responding signal RES, the control signals CTR₂ and CTR₁_{_{—}}₁ to CTR₁_{_{—}}₃, and a LED control signal ON. In the embodiment of FIG. 9, the push-button sensing signal SEN, the push-responding signal RES, the control signals CTR₂ and CTR₁_{_{—}}₁ to CTR₁_{_{—}}₃, and the LED control signal ON are digital signals.

As shown in FIG. 9, the push button is activated at time t1. Specifically, the push-button sensing signal SEN switches from a first state to a second state, e.g., from logic “1” to logic “0” at time t1. After a delay from t1 to t2, the push-responding signal RES is generated in response to button activation, for example, the push-responding signal RES has the first state, e.g., logic “1”, at t2 to control the monitoring circuit 304 to be powered on, and the control signal CTR₂ is enabled to control storage of the comparing signals 814.

After a delay, the control signals CTR₁_{_{—}}₁, CTR₁_{_{—}}₂, and CTR₁_{_{—}}₃ are activated in sequence. More specifically, at time t3, the signal CTR₁_{_{—}}₁ is enabled at t3, e.g., the control signal CTR₁_{_{—}}₁ is switched from logic “0” to logic “1”. The signal V_{MUX} is selected so that it is equal to the divided signal V_{D1}, and accordingly the comparator 802 compares the divided signal V_{D1} and the reference signal V_{R}, and the comparing signal 814 is stored in the data storage 804 of the storage module 816 in response to the control signal CTR₂. The signal CTR₁_{_{—}}₁ is disabled at t4. At time t5, the signal CTR₁_{_{—}}₂ is enabled, and accordingly the divided signal V_{D2} is selected to be compared with the reference signal V_{R}, and the comparing signal 814 is stored in the data storage 804 of the storage module 816 in response to the control signal CTR₂. The signal CTR₁_{_{—}}₂ is disabled at t6. At time t7, the operation of signal CTR₁_{_{—}}₃ is similar to that of the signals CTR₁_{_{—}}₁ and CTR₁_{_{—}}₂. For example, the signal CTR₁_{_{—}}₃ is enabled at time t7, the divided signal V_{D3} is selected to be compared with the reference signal V_{R}, and the comparing signal 814 is stored in the data storage 804 of the storage module 816 in response to the control signal CTR₂. The control signal CTR₁_{_{—}}₃ is disabled at t8.

After a delay from time t8 when the signal CTR₁_{_{—}}₃ is disabled and the comparing signals 814 have been stored in the storage module 806, the LED control signal ON is enabled at time t9. For example, the LED control signal ON is logic high to drive the LEDs 306_1-306_3 to indicate the SOC. Thus, the LEDs 306_1 to 306_3 can display the SOC of the battery pack according to the comparing signals 814 stored in the data storage 804 of the storage module 816. For example, the SOC of the battery pack is indicated to be above 80% when all three LEDs are turned on.

Advantageously, results of the comparisons between the battery pack voltage V_{B} and the reference signal V_{R} are stored; thus, the results of the comparisons are invariant prior to activating the SOC indicators 306, which ensures there will not be any flickering. The user will see a stable SOC indication each time the push button is activated. The SOC indication may include, for example, one, two, or three lit LEDs or one blinking LED.

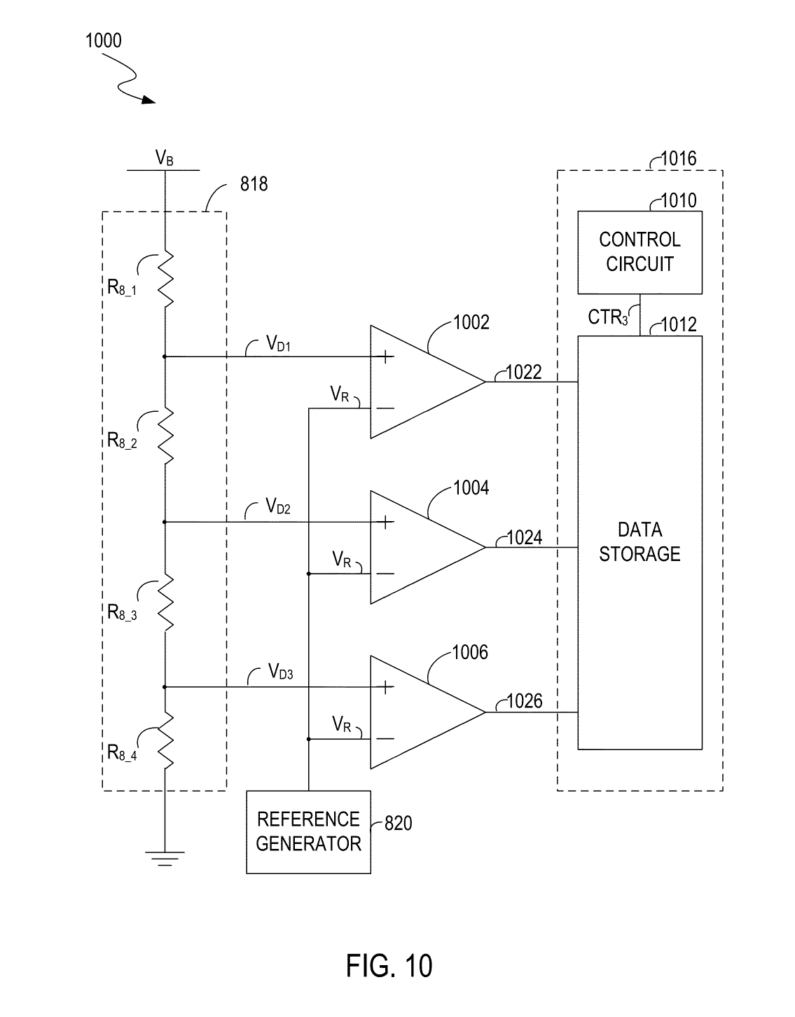

FIG. 10 illustrates an example of a monitoring circuit 1000 (e.g., the monitoring circuit 304 of FIG. 3), in an embodiment according to the present invention. Elements labeled the same as in FIG. 8 have similar functions. FIG. 10 is described in relation to FIG. 8. The monitoring circuit 1000 can be included in a single integrated circuit along with the delay timer mentioned above and along with the features of the monitoring circuits of FIG. 7A and FIG. 7B.

In one embodiment, the monitoring circuit 1000 includes a divider 818, a reference generator 820, multiple comparators 1002, 1004, and 1006, and a storage module 1016. In one embodiment, the divider 818 includes four resistors couple in series, a ratio among which is the same as the description in FIG. 8. The divider 818 provides divided voltages V_{D1} to V_{D3} to the comparator 1002, 1004, and 1006, respectively. Take the comparator 1002 for example. The comparator 1002 compares the divided voltage V_{D1} and the reference voltage V_{R} generated by the reference generator 820, and generates a comparing signal 1022 based upon a result of the comparison. The comparators 1004 and 1006 operate similar to the comparator 1002, and compare the divided voltages V_{D2} and V_{D3} with the reference voltage V_{R}, respectively, and generate the comparing signals 1024 and 1026, respectively. In one embodiment, the storage module 1016 includes data storage 1012 and a control circuit 1010. The data storage 1012 stores the comparing signals 1022, 1024, and 1026 according to a control signal CTR₃ generated by the control circuit 1010.

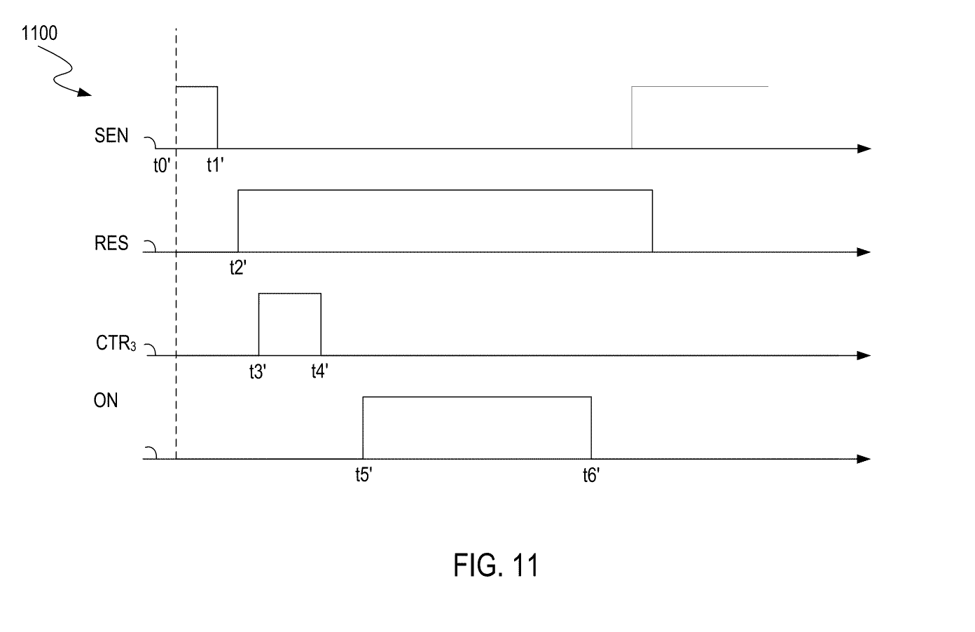

FIG. 11 illustrates a timing diagram 1100 of signals associated with the monitoring circuit 1000, in an embodiment according to the present invention. FIG. 11 is described in relation to FIG. 10. FIG. 11 shows the push-button sensing signal SEN, the push-responding signal RES, the control signal CTR₃, and a LED control signal ON.

As shown in FIG. 11, the button is activated, e.g., pushed, at time t1′. Thus, the push-button sensing signal SEN switches from a first state to a second state, e.g., from logic “1” to logic “0”, at time t1′. After a delay from t1′ to t2′, the push-responding signal RES is generated in response to the button activation at t2′. After another delay, at time t3′, the control signal CTR₃ is enabled. When the signal CTR₃ is enabled at t3′, e.g., switched from logic “0” to logic “1”, the data storage 1012 stores the comparing signals 1022, 1024, and 1026. After a delay from t4′ when the signal CTR₃ is disabled, at time t5′, the LED control signal ON is switched to a logic high state to drive the LEDs to indicate the SOC of the battery pack. Thus, the LEDs 306_1 to 306_3 can display the SOC of the battery pack.

Thus, advantageously, similar to the description in FIG. 8 and FIG. 9, results of the comparisons between the battery pack voltage V_{B} and the reference signal V_{R} are stored invariant prior to activating the SOC indicators 306, which ensures there will not be any flickering. The user will see a stable SOC indication each time the push button is activated.

In one embodiment, first the SOC of the battery pack is determined by one or more comparison results and then the results are stored in data storage. The SOC of the battery pack can be determined via a polling method that uses a single comparator, in which the battery pack voltage is compared to each threshold one-by-one, or via another method in which the battery pack voltage is compared to each threshold contemporaneously using multiple comparators. After the comparison results have been stored, a current is applied to the SOC indicator 306, so that the SOC indicator 306 indicates the SOC of the battery pack.

Essentially, three stages are implemented: measure stage (making a decision on what the SOC is), store stage (storing the decision), and display stage (displaying the decision). Thus, the measurement time interval (during which the SOC is determined) is separated from the indication time (at which the SOC is displayed to the user). This type of approach ensures there is a single SOC displayed on the LEDs per push button depression. In this manner, an unambiguous indication of SOC is provided to the user.

The various features described above can be implemented independently of one another or in combination. That is, the protection against faults feature, the positive indicator of SOC feature, and the non-flickering SOC indicator feature can each be implemented without the other features, or in any combination.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A method of operating a state-of-charge (SOC) indicator for a battery pack, said method comprising:
with said SOC indicator in a first mode, changing operation of said SOC indicator to a second mode if a mechanism is activated, wherein said SOC indicator consumes a first amount of power in said second mode; and
changing operation of said SOC indicator from said second mode to a third mode if said mechanism remains activated after a timer expires, wherein said SOC indicator consumes a second amount of power in said third mode, and wherein said second amount is less than said first amount.

2. The method as claimed in claim 1, further comprising:
changing operation of said SOC indicator from said second mode to said first mode if said mechanism is deactivated.

3. The method as claimed in claim 1, wherein said SOC indicator consumes a third amount of power when said SOC indicator operates in said first mode, wherein said second amount is greater than said third amount but less than said first amount.

4. The method as claimed in claim 1, wherein said SOC indicator is inactive when operating in said first mode, and is active when operating in said second mode.

5. The method as claimed in claim 1, further comprising:
monitoring SOC of said battery pack when said SOC indicator operates in said second mode;
generating a control signal indicating said SOC; and
displaying said SOC according to said control signal.

6. An apparatus for indicating a state-of-charge (SOC) of a battery pack, said apparatus comprising:
a first indicator, wherein said first indicator is turned on when said SOC is greater than a first threshold and is turned off when said SOC is less than said first threshold; and
a second indicator coupled to said first indicator, wherein said second indicator is turned on when said SOC is greater than a second threshold and blinks with a frequency when said SOC is less than said second threshold, wherein said second threshold is less than said first threshold.

7. The apparatus as claimed in claim 6, further comprising:
a comparator configured to compare a battery pack voltage and a predetermined reference voltage indicative of said second threshold and to generate a comparison signal;
a pulse generator configured to generate a pulse signal; and
a logic circuit coupled to said comparator and said pulse generator, said logic circuit configured to generate a switching signal according to said comparison signal and said pulse signal, wherein said second indicator blinks according to said switching signal.

8. The apparatus as claimed in claim 7, wherein said switching signal switches between a first value and a second value according to said pulse signal when said battery pack voltage is less than said predetermined reference voltage, so as to alternately turn on and off a current through said second indicator.

9. The apparatus as claimed in claim 8, wherein said second indicator is coupled to a transistor, and wherein said transistor receives said switching signal to control said current flowing through said second indicator.

10. The apparatus as claimed in claim 8, wherein said second indicator is coupled to a current source, wherein said current source is turned on or off according to said switching signal to control said current flowing through said second indicator.

11. The apparatus as claimed in claim 7, wherein the frequency at which said second indicator blinks is determined by the frequency of said pulse signal.

12. A circuit for monitoring state-of-charge (SOC) of a battery pack, said circuit comprising:
a divider configured to receive a battery pack voltage and to generate a first divided signal and a second divided signal that correspond to said battery pack voltage;
a first comparator configured to compare said first divided signal and a reference signal during a first time interval, and to generate a first comparing signal indicating said SOC of said battery pack based upon a result of said comparison; and
data storage coupled to said first comparator and configured to store said first comparing signal,
wherein a SOC indicator is configured to display an indication of said SOC of said battery pack during a second time interval based upon said first comparing signal stored in said data storage, wherein said second time interval is separated from said first time interval.

13. The circuit as claimed in claim 12, further comprising:
a multiplexer coupled to said divider and configured to select said first divided signal and said second divided signal in sequence,
wherein said first comparator compares said second divided signal and said reference signal to generate a second comparing signal after comparing said first divided signal and said reference signal, and wherein said data storage stores said second comparing signal after storing said first comparing signal.

14. The circuit as claimed in claim 13, further comprising:
a first control circuit coupled to said multiplexer and configured to generate a first control signal and a second control signal, wherein said first divided signal is selected by said multiplexer when said first control signal is enabled, and said second divided signal is selected when said second control signal is enabled.

15. The circuit as claimed in claim 14, wherein said SOC indicator displays said SOC after said second control signal is disabled and said second comparing signal is stored.

16. The circuit as claimed in claim 12, further comprising:
a second comparator configured to compare said second divided signal and said reference signal, and to generate a second comparing signal indicating said SOC of said battery pack based upon a result of said comparison,
wherein said data storage stores said second comparing signal contemporaneously with storing said first comparing signal.

17. The circuit as claimed in claim 16, wherein said SOC indicator displays said SOC according to said first comparing signal and said second comparing signal stored in said data storage.

18. The circuit as claimed in claim 12, wherein said divider comprises a plurality of resistors coupled in series, wherein a ratio among said resistors is set according to said reference signal, a first threshold corresponding a first level of said SOC for said battery pack, and a second threshold corresponding a second level of said SOC, and wherein said first level is higher than said second level.

19. The circuit as claimed in claim 18, wherein if said second comparing signal is greater than said reference signal then said SOC is greater than said first level, wherein if said second comparing signal is less than said reference signal and said first comparing signal is greater than said reference signal then said SOC is greater than said second level but less than said first level, and wherein if said first comparing signal is less than said reference signal then said SOC is less than said second level.

20. The circuit as claimed in claim 12, wherein said divider comprises a first resistor, a second resistor, and a third resistor, wherein a ratio between a total resistance of said first resistor, said second resistor, and said third resistor and a resistance of said third resistor is set equal to a ratio between a first predetermined voltage corresponding to said first threshold and said reference signal, and wherein said a ratio between said total resistance and a sum of the resistances of said second resistor and third resistor is set equal to a ratio between a second predetermined voltage corresponding to said second threshold and said reference signal.
